(19) United States
(12) Patent Application Publication
(10) Pub. No.: US 2025/0124726 A1
(43) Pub. Date: Apr. 17, 2025

(54) DIRECT IMAGE TO NYSTAGMUS ESTIMATION

(71) Applicant: Toyota Research Institute, Inc., Los Altos, CA (US)

(72) Inventors: JOHN H. GIDEON, Cincinnati, OH (US); Guy Rosman, Newton, MA (US); Kimimasa Tamura, Cambridge, MA (US); Pujitha Gunaratne, Northville, MI (US)

(73) Assignees: Toyota Research Institute, Inc., Los Altos, CA (US); Toyota Jidosha Kabushiki Kaisha, Toyota-shi (JP)

(21) Appl. No.: 18/485,106

(22) Filed: Oct. 11, 2023

(51) Int. Cl. G06V 20/59; B60W 60/00; G06V 10/82; G06V 40/18; G06V 40/20

(52) U.S. Cl. CPC G06V 20/597; G06V 10/82; G06V 40/18; G06V 40/20; B60W 60/0015; B60W 2420/403; B60W 2540/24

(57) ABSTRACT

Systems and methods are provided for determining intoxication in a driver. The system can receive data of a driver's face over a time interval and for each frame of the data, determine one or more parameters associated with eye movements and characteristics of the driver. Based on the one or more parameters for each frame, the frames can be featurized into one or more vectors, where each of the one or more vectors corresponds to a parameter of the one or more parameters. A weight can be applied to each of the one or more vectors and based on the weight of each of the one or more vectors, the system can predict whether the driver surpassed an intoxication threshold. If the driver surpassed the intoxication threshold, the system can alter an operating characteristic of a vehicle of the driver.

### TECHNICAL FIELD

The present disclosure relates generally to nystagmus in drivers operating a vehicle, and in particular, some implementations may relate to evaluating the driver's nystagmus to determine intoxication.

### DESCRIPTION OF RELATED ART

Nystagmus refers to a vision condition where eyes make repetitive, uncontrolled movements. Nystagmus can appear as a symptom of intoxication. Accordingly, a person's eye movements can be evaluated to determine if nystagmus is occurring. The presence of nystagmus can suggest that the person is intoxicated. Facial or eye video of the person can be used to determine the severity of nystagmus to determine the level of intoxication.

### BRIEF SUMMARY OF THE DISCLOSURE

According to various embodiments of the disclosed technology, a method can comprise receiving data of a driver's face over a time interval; for each frame of the data, determining one or more parameters associated with eye movements and characteristics of the driver; based on the one or more parameters for each frame, featurizing the frames into one or more vectors, wherein each of the one or more vectors corresponds to a parameter of the one or more parameters; applying a weight to each of the one or more vectors; based on the weight of each of the one or more vectors, predicting whether the driver surpassed an intoxication threshold; and if the driver surpassed the intoxication threshold, altering an operating characteristic of a vehicle of the driver.

In some embodiments, the one or more parameters comprise common characteristics, head pose, relative gaze, and patch appearance.

In some embodiments, the relative gaze parameter has a highest weight.

In some embodiments, the data comprises video data from a plurality of cameras.

In some embodiments, the method further comprises attributing a confidence value to each of the one or more vectors and weighting the one or more vectors based on the confidence values.

In some embodiments, the method further comprises determining an overall confidence value based on the confidence values and the weights.

In some embodiments, the one or more parameters evaluate how the frames change over the time interval.

In some embodiments, predicting whether the driver surpassed the intoxication threshold is accomplished with a temporal network.

According to various embodiments of the disclosed technology, a vehicle can comprise a sensor; a processor; and a memory coupled to the processor to store instructions, which when executed by the processor, cause the processor to: receive data of a driver's face over a time interval from the sensor; for each frame of the data, determine a relative gaze parameter; evaluate the relative gaze parameter over the time interval to predict whether the driver surpassed an intoxication threshold; and if the driver surpassed the intoxication threshold, alter an operating characteristic of the vehicle.

In some embodiments, the vehicle further comprises a plurality of sensors, wherein the data comprises video data from the plurality of sensors.

In some embodiments, the processor is further configured to attribute a confidence value to the prediction of whether the driver surpassed the intoxication threshold.

In some embodiments, wherein predicting whether the driver surpassed the intoxication threshold is accomplished with a temporal network.

In some embodiments, the processor is further configured to train the temporal network based on the relative gaze parameter.

In some embodiments, the processor is further configured to: for each frame of the data, determine a head pose parameter, a common characteristic parameter, and a patch appearance parameter; and evaluate the head pose parameter, the common characteristic parameter, and the patch appearance parameter over the time interval to predict whether the driver surpassed the intoxication threshold.

According to various embodiments of the disclosed technology, a non-transitory machine-readable medium can have instructions stored therein, which when executed by a processor, causes the processor to: receive video data of a driver's face over a time interval; for each frame of the video data, determining one or more parameters associated with eye movements and characteristics of the driver; based on the one or more parameters for each frame, featurize the frames into one or more vectors, wherein each of the one or more vectors corresponds to a parameter of the one or more parameters; attribute a confidence value to each of the one or more vectors; based on the confidence value of each of the one or more vectors, predict whether the driver surpassed an intoxication threshold; and if the driver surpassed the intoxication threshold, alter an operating characteristic of a vehicle of the driver.

In some embodiments, the one or more parameters comprise common characteristics, head pose, relative gaze, and patch appearance.

In some embodiments, the processor is further configured to determine an overall confidence value based on the confidence values.

In some embodiments, the one or more parameters evaluate how the frames change over the time interval.

In some embodiments, predicting whether the driver surpassed the intoxication threshold is accomplished with a temporal network.

In some embodiments, the processor is further configured to train the temporal network based on the confidence values.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a schematic representation of an example hybrid vehicle with which embodiments of the systems and methods disclosed herein may be implemented.

FIG. 2 illustrates an example architecture for detecting intoxication in accordance with one embodiment of the systems and methods described herein.

FIG. 3 illustrates an example system for predicting intoxication in a driver in accordance with one embodiment.

FIG. 4 illustrates an example method for predicting intoxication in a driver in accordance with one embodiment.

FIG. 5 is an example computing component that may be used to implement various features of embodiments described in the present disclosure.

The figures are not exhaustive and do not limit the present disclosure to the precise form disclosed.

### DETAILED DESCRIPTION

Intoxicated drivers often exhibit various physical indicators of intoxication, one of which, alluded to above, is nystagmus. In particular, the severity of nystagmus can be indicative of a person's level of intoxication. In the context of autonomous driving, the level of intoxication can inform various aspects of an autonomous system. For example, an autonomous system may engage automated driving maneuvers to steer and/or guide a vehicle so that an intoxicated driver does not have to execute manual maneuvers. An autonomous system may also execute safety maneuvers to bring a vehicle to a safe stop/location. Furthermore, an autonomous system can send notifications about a driver's status in the case of a medical emergency. In light of the above example scenarios, an autonomous driving system can use a prediction of intoxication to adapt the autonomous driving environment to a particular driver's needs and capabilities.

Embodiments of the systems and methods disclosed herein can analyze horizontal gaze nystagmus (HGN) exhibited by a driver's eye movement by recording video of the driver's face or eyes. This video can take place as a driver is driving a vehicle on a road, during a simulation, or prior to driving on a road. Here, HGN refers to the horizontal movement of a driver's eye from left to right and vice versa. In some embodiments, vertical gaze nystagmus can be analyzed to make additional predictions. Using this data, a prediction can be made to estimate the level of intoxication in a driver. The level of intoxication can be indicated by a predicted blood alcohol content (BAC) or other measurement of intoxication.

The embodiments described herein can utilize an image encoder that trains by contrastive learning and reduces captured video data into one or more vectors. These vectors can indicate various parameters and probabilities related to the video data, such as camera identity, driver characteristics, gaze position, and pose estimate. These individual encoded vectors can be used to reconstruct the image or estimate the driver's gaze and/or other characteristics. Multiple encodings over time can be used to estimate the driver's HGN state/drunkenness level. The driver's HGN state can be used to make various different predictions, including predicted intoxication, vertigo, or other conditions associated with HGN indicators. This system can be trained with HGN and non-HGN sequences via temporal regression and regularization. The model takes a list of encoded vectors over time as an input and determines the presence of HGN throughout the video. This overall approach allows the system to train with fewer examples of HGN to leverage a large amount of driver-facing unsupervised video and sensor data. As mentioned above, the trained system can produce predictions that can be used to change vehicle operating characteristics in an autonomous driving system. Changing vehicle operating characteristics can include, but are not limited to, executing safety maneuvers, executing automated driving maneuvers, sending alerts or notifications to third parties, and/or providing instructions/notice to the driver.

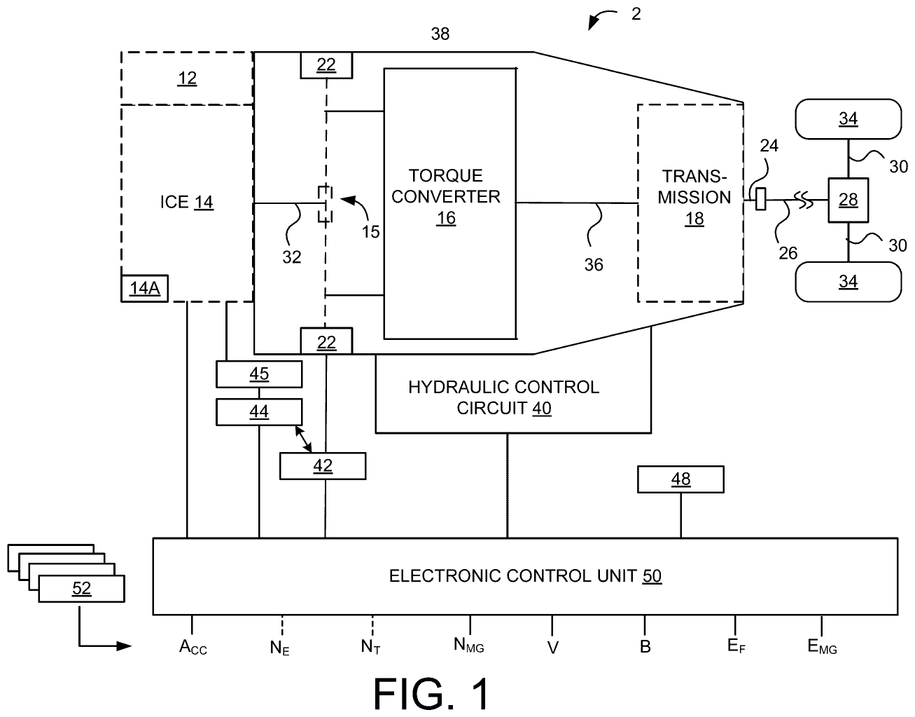

The systems and methods disclosed herein may be implemented with any of a number of different vehicles and vehicle types. For example, the systems and methods disclosed herein may be used with automobiles, trucks, motorcycles, recreational vehicles and other like on- or off-road vehicles. In addition, the principals disclosed herein may also extend to other vehicle types as well. An example hybrid electric vehicle (HEV) in which embodiments of the disclosed technology may be implemented is illustrated in FIG. 1. Although the example described with reference to FIG. 1 is a hybrid type of vehicle, the systems and methods for predicting intoxication in a driver can be implemented in other types of vehicles including gasoline- or diesel-powered vehicles, fuel-cell vehicles, electric vehicles, or other vehicles.

FIG. 1 illustrates a drive system of a vehicle 100 that may include an internal combustion engine 14 and one or more electric motors 22 (which may also serve as generators) as sources of motive power. Driving force generated by the internal combustion engine 14 and motors 22 can be transmitted to one or more wheels 34 via a torque converter 16, a transmission 18, a differential gear device 28, and a pair of axles 30.

As an HEV, vehicle 2 may be driven/powered with either or both of engine 14 and the motor(s) 22 as the drive source for travel. For example, a first travel mode may be an engine-only travel mode that only uses internal combustion engine 14 as the source of motive power. A second travel mode may be an EV travel mode that only uses the motor(s) 22 as the source of motive power. A third travel mode may be an HEV travel mode that uses engine 14 and the motor(s) 22 as the sources of motive power. In the engine-only and HEV travel modes, vehicle 100 relies on the motive force generated at least by internal combustion engine 14, and a clutch 15 may be included to engage engine 14. In the EV travel mode, vehicle 2 is powered by the motive force generated by motor 22 while engine 14 may be stopped and clutch 15 disengaged.

Engine 14 can be an internal combustion engine such as a gasoline, diesel or similarly powered engine in which fuel is injected into and combusted in a combustion chamber. A cooling system 12 can be provided to cool the engine 14 such as, for example, by removing excess heat from engine 14. For example, cooling system 12 can be implemented to include a radiator, a water pump and a series of cooling channels. In operation, the water pump circulates coolant through the engine 14 to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of engine 14. In other applications, either or both the water pump and the fan may be operated by electric current such as from battery 44.

An output control circuit 14A may be provided to control drive (output torque) of engine 14. Output control circuit 14A may include a throttle actuator to control an electronic throttle valve that controls fuel injection, an ignition device that controls ignition timing, and the like. Output control circuit 14A may execute output control of engine 14 according to a command control signal(s) supplied from an electronic control unit 50, described below. Such output control can include, for example, throttle control, fuel injection control, and ignition timing control.

Motor 22 can also be used to provide motive power in vehicle 2 and is powered electrically via a battery 44. Battery 44 may be implemented as one or more batteries or other power storage devices including, for example, lead-acid batteries, nickel-metal hydride batteries, lithium-ion batteries, capacitive storage devices, and so on. Battery 44 may be charged by a battery charger 45 that receives energy from internal combustion engine 14. For example, an alternator or generator may be coupled directly or indirectly to a drive shaft of internal combustion engine 14 to generate an electrical current as a result of the operation of internal combustion engine 14. A clutch can be included to engage/disengage the battery charger 45. Battery 44 may also be charged by motor 22 such as, for example, by regenerative braking or by coasting during which time motor 22 operate as generator.

Motor 22 can be powered by battery 44 to generate a motive force to move the vehicle and adjust vehicle speed. Motor 22 can also function as a generator to generate electrical power such as, for example, when coasting or braking. Battery 44 may also be used to power other electrical or electronic systems in the vehicle. Motor 22 may be connected to battery 44 via an inverter 42. Battery 44 can include, for example, one or more batteries, capacitive storage units, or other storage reservoirs suitable for storing electrical energy that can be used to power motor 22. When battery 44 is implemented using one or more batteries, the batteries can include, for example, nickel metal hydride batteries, lithium-ion batteries, lead acid batteries, nickel cadmium batteries, lithium-ion polymer batteries, and other types of batteries.

An electronic control unit 50 (described below) may be included and may control the electric drive components of the vehicle as well as other vehicle components. For example, electronic control unit 50 may control inverter 42, adjust driving current supplied to motor 22, and adjust the current received from motor 22 during regenerative coasting and breaking. As a more particular example, output torque of the motor 22 can be increased or decreased by electronic control unit 50 through the inverter 42.

A torque converter 16 can be included to control the application of power from engine 14 and motor 22 to transmission 18. Torque converter 16 can include a viscous fluid coupling that transfers rotational power from the motive power source to the driveshaft via the transmission. Torque converter 16 can include a conventional torque converter or a lockup torque converter. In other embodiments, a mechanical clutch can be used in place of torque converter 16.

Clutch 15 can be included to engage and disengage engine 14 from the drivetrain of the vehicle. In the illustrated example, a crankshaft 32, which is an output member of engine 14, may be selectively coupled to the motor 22 and torque converter 16 via clutch 15. Clutch 15 can be implemented as, for example, a multiple disc type hydraulic frictional engagement device whose engagement is controlled by an actuator such as a hydraulic actuator. Clutch 15 may be controlled such that its engagement state is complete engagement, slip engagement, and complete disengagement complete disengagement, depending on the pressure applied to the clutch. For example, a torque capacity of clutch 15 may be controlled according to the hydraulic pressure supplied from a hydraulic control circuit (not illustrated). When clutch 15 is engaged, power transmission is provided in the power transmission path between the crankshaft 32 and torque converter 16. On the other hand, when clutch 15 is disengaged, motive power from engine 14 is not delivered to the torque converter 16. In a slip engagement state, clutch 15 is engaged, and motive power is provided to torque converter 16 according to a torque capacity (transmission torque) of the clutch 15.

As alluded to above, vehicle 100 may include an electronic control unit 50. Electronic control unit 50 may include circuitry to control various aspects of the vehicle operation. Electronic control unit 50 may include, for example, a microcomputer that includes a one or more processing units (e.g., microprocessors), memory storage (e.g., RAM, ROM, etc.), and I/O devices. The processing units of electronic control unit 50, execute instructions stored in memory to control one or more electrical systems or subsystems in the vehicle. Electronic control unit 50 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS or ESC), battery management systems, and so on. These various control units can be implemented using two or more separate electronic control units, or using a single electronic control unit.

In the example illustrated in FIG. 1, electronic control unit 50 receives information from a plurality of sensors included in vehicle 100. For example, electronic control unit 50 may receive signals that indicate vehicle operating conditions or characteristics, or signals that can be used to derive vehicle operating conditions or characteristics. These may include, but are not limited to accelerator operation amount, A_{CC}, a revolution speed, N_{E}, of internal combustion engine 14 (engine RPM), a rotational speed, N_{MG}, of the motor 22 (motor rotational speed), and vehicle speed, N_{V}. These may also include torque converter 16 output, N_{T} (e.g., output amps indicative of motor output), brake operation amount/pressure, B, battery SOC (i.e., the charged amount for battery 44 detected by an SOC sensor). Accordingly, vehicle 100 can include a plurality of sensors 52 that can be used to detect various conditions internal or external to the vehicle and provide sensed conditions to engine control unit 50 (which, again, may be implemented as one or a plurality of individual control circuits). In one embodiment, sensors 52 may be included to detect one or more conditions directly or indirectly such as, for example, fuel efficiency, E_{F}, motor efficiency, E_{MG}, hybrid (internal combustion engine 14+MG 12) efficiency, acceleration, A_{CC}, etc.

In some embodiments, one or more of the sensors 52 may include their own processing capability to compute the results for additional information that can be provided to electronic control unit 50. In other embodiments, one or more sensors may be data-gathering-only sensors that provide only raw data to electronic control unit 50. In further embodiments, hybrid sensors may be included that provide a combination of raw data and processed data to electronic control unit 50. Sensors 52 may provide an analog output or a digital output.

Sensors 52 may be included to detect not only vehicle conditions but also to detect external conditions as well. Sensors that might be used to detect external conditions can include, for example, sonar, radar, lidar or other vehicle proximity sensors, and cameras or other image sensors. Image sensors can be used to detect, for example, traffic signs indicating a current speed limit, road curvature, obstacles, and so on. Still other sensors may include those that can detect road grade. While some sensors can be used to actively detect passive environmental objects, other sensors can be included and used to detect active objects such as those objects used to implement smart roadways that may actively transmit and/or receive data or other information.

The example of FIG. 1 is provided for illustration purposes only as one example of vehicle systems with which embodiments of the disclosed technology may be implemented. One of ordinary skill in the art reading this description will understand how the disclosed embodiments can be implemented with this and other vehicle platforms.

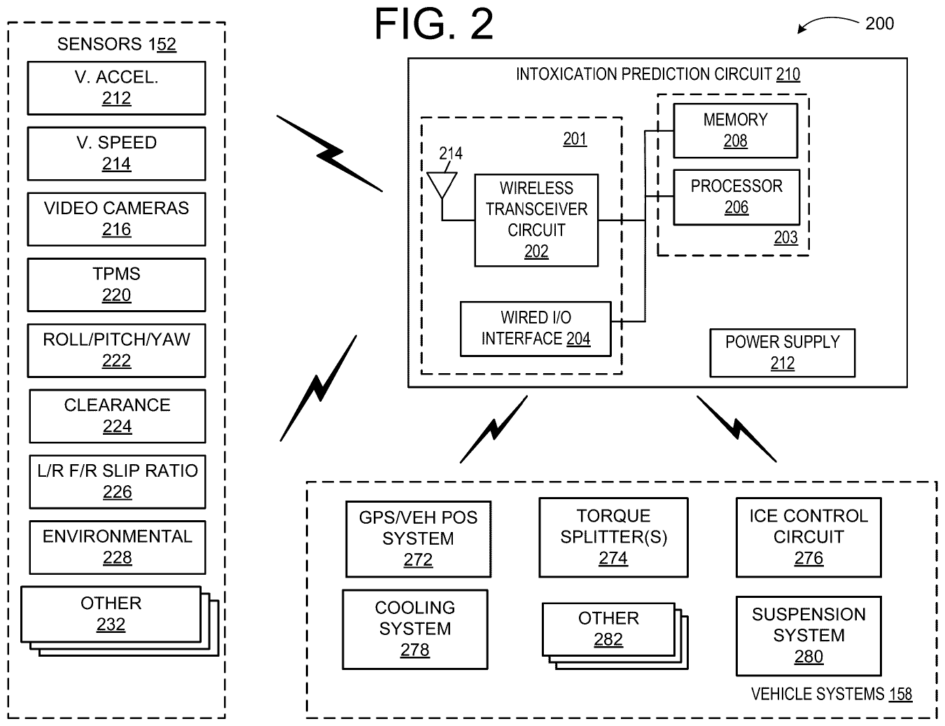

FIG. 2 illustrates an example architecture for predicting intoxication in a driver in accordance with one embodiment of the systems and methods described herein. In some embodiments, intoxication prediction system 200 can be implemented in-vehicle to execute while a driver is operating the vehicle. In other embodiments, intoxication prediction system 200 can operate over a cloud or other network. Referring now to FIG. 2, in this example, intoxication prediction system 200 includes an intoxication prediction circuit 210, a plurality of sensors 152 and a plurality of vehicle systems 158.

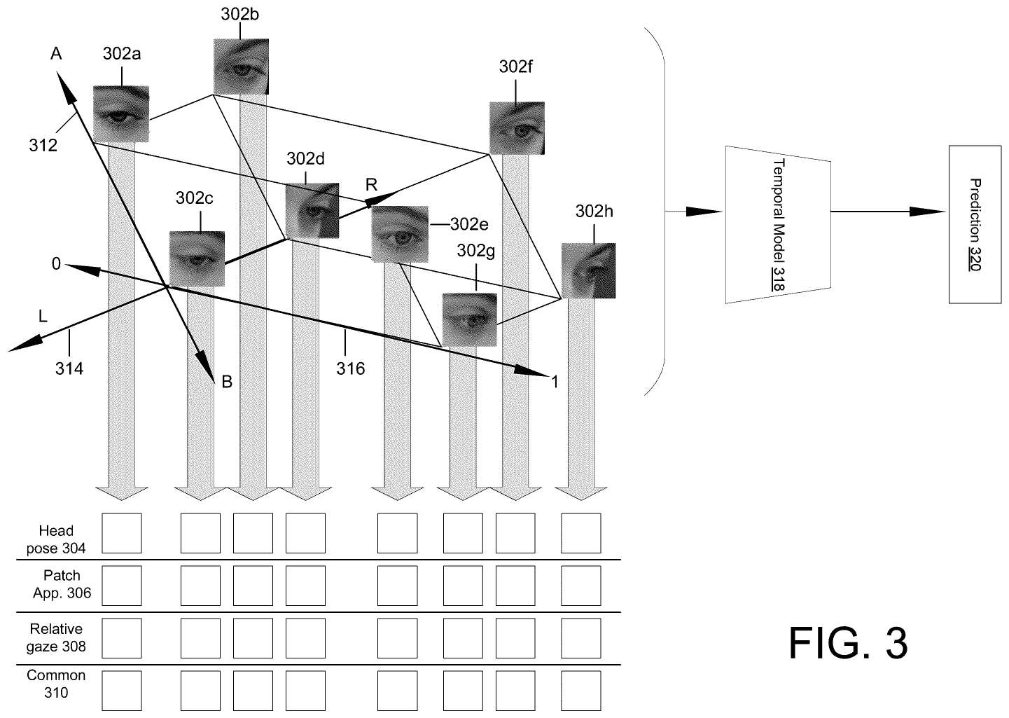

As described further below in FIG. 3, sensors 152 can communicate image and video data of a driver while the vehicle is in operation. In particular, sensors 152 can include image and video sensors to obtain images and video of the driver's face and eyes. Sensors 152 can communicate this data to intoxication prediction circuit 210 to determine whether the driver is intoxicated.

Sensors 152 and vehicle systems 158 can communicate with intoxication prediction circuit 210 via a wired or wireless communication interface. Although sensors 152 and vehicle systems 158 are depicted as communicating with intoxication prediction circuit 210, they can also communicate with each other as well as with other vehicle systems. In embodiments where intoxication prediction circuit 210 is implemented in-vehicle, intoxication prediction circuit 210 can be implemented as an ECU or as part of an ECU such as, for example electronic control unit 50. In other embodiments, intoxication prediction circuit 210 can be implemented independently of the ECU, such that sensors 152 and vehicle systems 158 can communicate to intoxication prediction circuit 210 over a network, server or cloud interface. In embodiments where intoxication prediction circuit 210 operates over a network, intoxication prediction circuit 210 can execute the architecture described below in FIG. 3 and communicate back to sensors 152 and vehicle systems 158.

Intoxication prediction circuit 210 in this example includes a communication circuit 201, a decision circuit 203 (including a processor 206 and memory 208 in this example) and a power supply 212. Components of intoxication prediction circuit 210 are illustrated as communicating with each other via a data bus, although other communication in interfaces can be included. Intoxication prediction circuit 210 can receive sensor data as described above and input that sensor data into one or more machine learning algorithms through decision circuit 203. Decision circuit 203 can execute a neural network to evaluate each frame of the video data over a time interval. The neural network can determine one or more vectors associated with the video data. Each vector can be weighted to make an overall prediction of whether the driver has exceeded an intoxication threshold. As described further below, intoxication prediction circuit 210 can use the final prediction to determine whether to alter operating characteristics of the vehicle. Intoxication prediction circuit 210 can communicate with vehicle systems 158 through communication circuit 201 in response to a determination that the driver is intoxicated.

Processor 206 can include one or more GPUs, CPUs, microprocessors, or any other suitable processing system. Processor 206 may include a single core or multicore processors. The memory 208 may include one or more various forms of memory or data storage (e.g., flash, RAM, etc.) that may be used to store the calibration parameters, images (analysis or historic), point parameters, instructions and variables for processor 206 as well as any other suitable information. Memory 208 can be made up of one or more modules of one or more different types of memory and may be configured to store data and other information as well as operational instructions that may be used by the processor 206 to intoxication prediction circuit 210.

Although the example of FIG. 2 is illustrated using processor and memory circuitry, as described below with reference to circuits disclosed herein, decision circuit 203 can be implemented utilizing any form of circuitry including, for example, hardware, software, or a combination thereof. By way of further example, one or more processors, controllers, ASICs, PLAS, PALs, CPLDs, FPGAs, logical components, software routines or other mechanisms might be implemented to make up an intoxication prediction circuit 210.

Communication circuit 201 either or both a wireless transceiver circuit 202 with an associated antenna 205 and a wired I/O interface 204 with an associated hardwired data port (not illustrated). Communication circuit 201 can provide for V2X and/or V2V communications capabilities, allowing intoxication prediction circuit 210 to communicate with edge devices, such as roadside unit/equipment (RSU/RSE), network cloud servers and cloud-based databases, and/or other vehicles via a network. For example, V2X communication capabilities allows intoxication prediction circuit 210 to communicate with edge/cloud devices, roadside infrastructure (e.g., such as roadside equipment/roadside unit, which may be a vehicle-to-infrastructure (V2I)-enabled streetlight or cameras, for example), etc. Local intoxication prediction circuit 210 may also communicate with other connected vehicles over vehicle-to-vehicle (V2V) communications. For example, current driving conditions/environment data may include data relayed to the ego vehicle from, e.g., an RSE (instead of from an on-board sensor, such as sensors 252), which can then be relayed to the intoxication prediction server.

As used herein, “connected vehicle” refers to a vehicle that is actively connected to edge devices, other vehicles, and/or a cloud server via a network through V2X, V2I, and/or V2V communications. An “unconnected vehicle” refers to a vehicle that is not actively connected. That is, for example, an unconnected vehicle may include communication circuitry capable of wireless communication (e.g., V2X, V2I, V2V, etc.), but for whatever reason is not actively connected to other vehicles and/or communication devices. For example, the capabilities may be disabled, unresponsive due to low signal quality, etc. Further, an unconnected vehicle, in some embodiments, may be incapable of such communication, for example, in a case where the vehicle does not have the hardware/software providing such capabilities installed therein.

As this example illustrates, communications with intoxication prediction circuit 210 can include either or both wired and wireless communications circuits 201. Wireless transceiver circuit 202 can include a transmitter and a receiver (not shown) to allow wireless communications via any of a number of communication protocols such as, for example, Wifi, Bluetooth, near field communications (NFC), Zigbee, and any of a number of other wireless communication protocols whether standardized, proprietary, open, point-to-point, networked or otherwise. Antenna 205 is coupled to wireless transceiver circuit 202 and is used by wireless transceiver circuit 202 to transmit radio signals wirelessly to wireless equipment with which it is connected and to receive radio signals as well. These RF signals can include information of almost any sort that is sent or received by intoxication prediction circuit 210 to/from other entities such as sensors 152 and vehicle systems 158.

Wired I/O interface 204 can include a transmitter and a receiver (not shown) for hardwired communications with other devices. For example, wired I/O interface 204 can provide a hardwired interface to other components, including sensors 152 and vehicle systems 158. Wired I/O interface 204 can communicate with other devices using Ethernet or any of a number of other wired communication protocols whether standardized, proprietary, open, point-to-point, networked or otherwise.

Power supply 210 can include one or more of a battery or batteries (such as, e.g., Li-ion, Li-Polymer, NiMH, NiCd, NiZn, and NiH₂, to name a few, whether rechargeable or primary batteries), a power connector (e.g., to connect to vehicle supplied power, etc.), an energy harvester (e.g., solar cells, piezoelectric system, etc.), or it can include any other suitable power supply.

Sensors 152 can include, for example, sensors 52 such as those described above with reference to the example of FIG. 1. Sensors 152 can include additional sensors that may or may not otherwise be included on a standard vehicle 10 with which the intoxication prediction system 200 is implemented. In the illustrated example, sensors 152 include vehicle acceleration sensors 212, vehicle speed sensors 214, video cameras 216 (to record and driver's face and eye movements over time), a tire pressure monitoring system (TPMS) 220, accelerometers such as a 3-axis accelerometer 222 to detect roll, pitch and yaw of the vehicle, vehicle clearance sensors 224, left-right and front-rear slip ratio sensors 226, and environmental sensors 228 (e.g., to detect salinity or other environmental conditions). Additional sensors 232 can also be included as may be appropriate for a given implementation of intoxication prediction system 200.

Vehicle systems 158 can include any of a number of different vehicle components or subsystems used to control or monitor various aspects of the vehicle and its performance. In this example, the vehicle systems 158 include a GPS or other vehicle positioning system 272; torque splitters 274 that can control distribution of power among the vehicle wheels such as, for example, by controlling front/rear and left/right torque split; engine control circuits 276 to control the operation of engine (e.g. Internal combustion engine 14); cooling systems 278 to provide cooling for the motors, power electronics, the engine, or other vehicle systems; suspension system 280 such as, for example, an adjustable-height air suspension system, or an adjustable-damping suspension system; and other vehicle systems 282.

Communication circuit 201 can be used to transmit and receive information between intoxication prediction circuit 210 and sensors 152, and intoxication prediction circuit 210 and vehicle systems 158. Also, sensors 152 may communicate with vehicle systems 158 directly or indirectly (e.g., via communication circuit 201 or otherwise).

FIG. 3 illustrates an example system for predicting intoxication in accordance with various embodiments. A system can include one or more video cameras focused on a driver's face or eyes. In some embodiments, four different cameras can be used to train the neural network, while two to four cameras can be used when executing the trained neural network. Inferences can be made using only one camera; however, additional cameras can provide increased accuracy in predictions. In the example of FIG. 3, the system uses two cameras A and B. Video from cameras A and B can be separated into frames of the driver's eyes. Here, a patch can refer to the section of the frame comprising one of the driver's eyes. Each frame can have a patch for the driver's left eye and a patch for the driver's right eye. Illustrated in FIG. 3 are patches 302a-h. Patches 302a-d are representative of a frame at time t=0. 302a and 302b can be derived from camera A, while 302c and 302d can be derived from camera B. Patches 302a and 302c illustrate the driver's left eye, while patches 302b and 302d illustrate the driver's right eye. Similarly, patches 302e-303h are representative of a frame at time t=1. 302e and 302f can be derived from camera A, while 302g and 302h can be derived from camera B. Patches 302e and 302g illustrate the driver's left eye, while patches 302f and 302h illustrate the driver's right eye. Patches 302a-h are illustrated in FIG. 3 as plotted on three axes 312-316. Axis 312 runs from camera A to camera B. Axis 314 runs from left eye to right eye. Axis 316 runs from time t=0 to time t=1. The axes in FIG. 3 are illustrative of two frames of videos across two cameras and two time points. These axes can extend as necessary depending on the number of cameras, the number of frames, and the time intervals.

An encoder model can be used to extract information from each patch to form one or more vectors associated with the frame. The encoder model can featurize each patch into these one or more vectors. In the example of FIG. 3, the encoder model can featurize each patch into four vectors: head pose 304, patch appearance 306, relative gaze 308, and common features 310. Head pose vector 304 can comprise information on the driver's head orientation and scale relative to the camera. Head pose vector 304 corresponds to axis 312 and also includes information on the camera including the camera's position and/or identity, as well as preserving background features particular to each camera. Patch appearance vector 306 can include information on the eye's appearance and identity. For example, patch appearance vector 306 can correspond to axis 314 and can include information on which eye is being imaged. It is possible to encode other patches besides eyes-including full face patches. These different patch types can be distinguished by using appearance vector 306. Relative gaze vector 308 can include information related to the gaze angle relative to the head pose. Relative gaze vector 308 can correspond to axis 316 and include features that vary quickly over time, including eye glances. In some embodiments, the system can operate with only relative gaze vector 308, as this is the main vector aimed at encoding changes over time. However, the additional application of vectors 304, 306, and 310 can increase accuracy in the predictions due to the increased depth of analysis of each frame. Each of vectors 304-310 comprise a time component to measure the changes in patches over time.

To train the system, vectors 304-310 can be applied to a decoder model that can recreate the featurized patches. Each patch can be annotated with levels of intoxication or other indicators for purposes of training the system. The model can be retrained and updated as needed to account for additional or different vectors, additional or larger data sets, and/or any other information applied to the system. The system can be trained to specific drivers who may have unique HGN levels associated with varying levels of intoxication. In some embodiments, the model can be trained based on specific drivers and can be deployed to evaluate different drivers. For example, the system may be trained based on data associated with driver A. The trained system can evaluate data associated with driver B and make appropriate predictions with associated confidence values.

Once the neural network is trained, vectors 304-310 can be sent to temporal model 318, which can evaluate vectors 304-310 to make predictions as to the levels of HGN and/or intoxication. Temporal model 318 can associate confidence values and/or probabilities to each vector that represent the levels of HGN. The confidence value can indicate the confidence the system has in the vector determining the level of HGN. An overall confidence value can consolidate the vector confidence values for a more generalized interpretation. To determine an overall confidence value or probability, each vector may be associated with a weight that affects the overall confidence value or probability. For example, the relative gaze vector may be associated with a highest weight in determining overall confidence. In some embodiments, the overall confidence value may increase with the use of additional vectors due to the additional layers of analysis. However, as mentioned above, the system can evaluate video data based on one vector. Vectors can be evaluated over a time period in order to generate a probability and/or confidence value. For example, after evaluating relative gaze vector 308 over a time period, temporal model 318 may attribute an 80% probability that the eye is experiencing HGN. The probability may be associated with levels of HGN related to certain levels of intoxication. The probability can relate to surpassing a threshold level of HGN or intoxication. For example, a level of HGN may suggest that the person is intoxicated past the legal BAC limit. Accordingly, a probability may suggest that there's an 80% probability that the driver is intoxicated past the legal BAC limit.

Temporal model 318 can produce predictions 320 based on the probabilities and confidence values. These predictions can be used in various ways to increase a driver's level of safety. For example, if the system in FIG. 3 is applied in vehicle, predictions 320 can be communicated directly to the vehicle systems to change vehicle operating characteristics. In an autonomous driving system, predictions 320 can result in various automatic driving maneuvers, alerts, and/or notifications to prevent intoxicated driving. For example, automatic driving maneuvers can include pulling over safely to the side of the road, engaging automatic steering, and/or slowly applying the brakes to bring the vehicle to a stop. The intoxicated driver can be alerted or notified in vehicle to pull over or stop driving. The vehicle may communicate with emergency services if the driver is experiencing a severe level of intoxication. If the system in FIG. 3 is applied outside of the vehicle, i.e., over a network or cloud, the system can send transmissions to the vehicle to engage automatic driving maneuvers or transmit notifications. Predictions 320 can be used in various implementations to protect the potentially intoxicated driver.

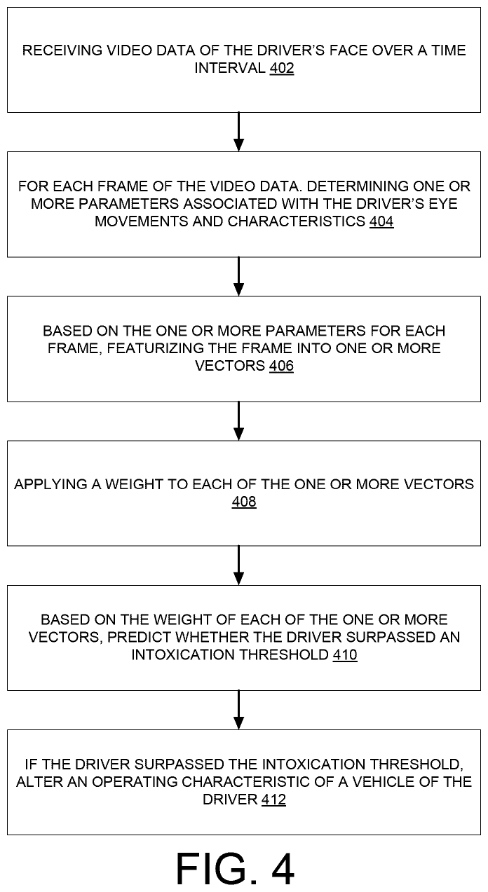

FIG. 4 illustrates an example method in accordance with the embodiments described above. At step 402, the system can receive video data of a driver's face over a time interval. As described above, video data may come from one or more video cameras focused on a driver's face or eyes. These video cameras can be located inside a vehicle as a driver is operating a vehicle. Alternatively, the video cameras may be located in a testing environment or simulated driving environment. Video data may occur before or during operation of a vehicle. In some embodiments, four different cameras can be used to train the encoder neural network, while two to four cameras can be used when executing the trained neural network. Inferences can be made using only one camera; however, additional cameras can provide increased accuracy in predictions. Video data can be separated into frames of the driver's eyes. Each frame can comprise one or more patches that focus on a particular eye.

At step 404, the system can determine one or more parameters associated with eye movements and characteristics of the driver. As described above, an encoder model can be used to extract information from each patch to form one or more vectors associated with the frame. Vectors may be associated with head pose, patch appearance, relative gaze, and common features. Head pose can relate to the driver's head orientation relative to the camera. Patch appearance can relate to the eye's appearance and identity. Relative gaze can relate to the gaze angle relative to the head pose. In some embodiments, the system can operate with only the relative gaze parameter. Each parameter can comprise a time component to measure the changes in patches over time. At step 406, the system can featurize the frames into one or more vectors based on the one or more parameters for each frame. Each of the one or more vectors can correspond to a parameter of the one or more parameters.

At step 408, the system can apply a weight to each of the one or more vectors. As described above, a temporal model can associate confidence values and/or probabilities to each vector that represent the levels of HGN. An overall confidence value can consolidate the vector confidence values for a more generalized interpretation. To determine an overall confidence value or probability, each vector may be associated with a weight that affects the overall confidence value. In some embodiments, the overall confidence value may increase with the use of additional vectors due to the additional layers of analysis. Vectors can be evaluated over a time period in order to generate a probability and/or confidence value. At step 410, the system can predict whether the driver surpassed an intoxication threshold based on the weight of each of the one or more vectors. As described above, the temporal model can produce predictions based on the probabilities and confidence values.

At step 412, the system can alter an operating characteristic of a vehicle of the driver if the driver surpassed the intoxication threshold. As described above, the system can be applied in vehicle or over a network to communicate changes to a vehicle's operating characteristics. In an autonomous driving system, the vehicle can execute automatic driving maneuvers, alerts, and/or notifications to prevent intoxicated driving. The vehicle may communicate with emergency services of the driver is experiencing a severe level of intoxication. If the system is applied outside of the vehicle, i.e., over a network or cloud, the system can send transmissions to the vehicle to engage automatic driving maneuvers or transmit notifications.

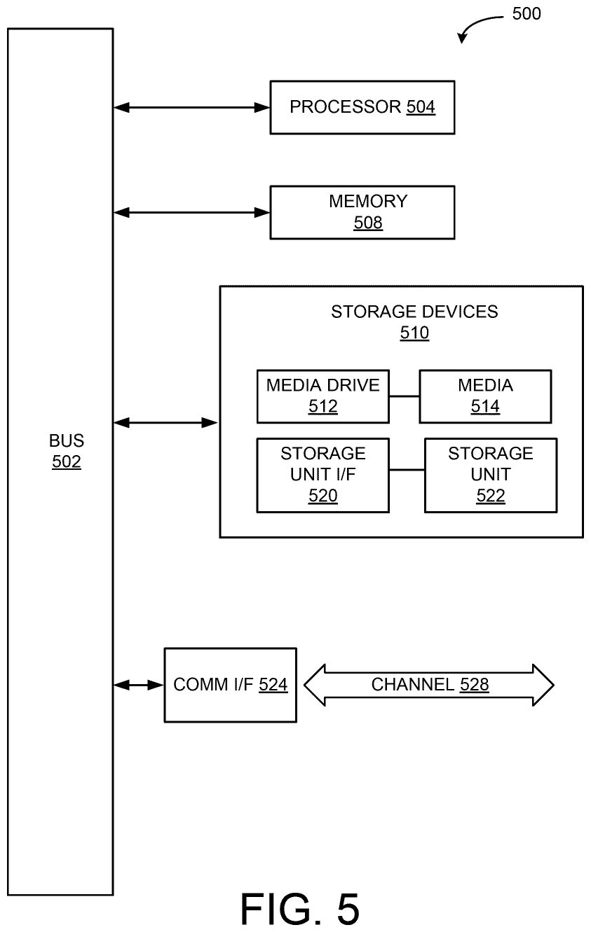

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAS, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionalities can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 5. Various embodiments are described in terms of this example-computing component 500. After reading this description, it will become apparent to a person skilled in the relevant art how to implement the application using other computing components or architectures.

Referring now to FIG. 5, computing component 500 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 500 might also represent computing capabilities embedded within or otherwise available to a given device. For example, a computing component might be found in other electronic devices such as, for example, portable computing devices, and other electronic devices that might include some form of processing capability.

Computing component 500 might include, for example, one or more processors, controllers, control components, or other processing devices. Processor 504 might be implemented using a general-purpose or special-purpose processing engine such as, for example, a microprocessor, controller, or other control logic. Processor 504 may be connected to a bus 502. However, any communication medium can be used to facilitate interaction with other components of computing component 500 or to communicate externally.

Computing component 500 might also include one or more memory components, simply referred to herein as main memory 508. For example, random access memory (RAM) or other dynamic memory, might be used for storing information and instructions to be executed by processor 504. Main memory 508 might also be used for storing temporary variables or other intermediate information during execution of instructions to be executed by processor 504. Computing component 500 might likewise include a read only memory (“ROM”) or other static storage device coupled to bus 502 for storing static information and instructions for processor 504.

The computing component 500 might also include one or more various forms of information storage mechanism 510, which might include, for example, a media drive 512 and a storage unit interface 520. The media drive 512 might include a drive or other mechanism to support fixed or removable storage media 514. For example, a hard disk drive, a solid-state drive, a magnetic tape drive, an optical drive, a compact disc (CD) or digital video disc (DVD) drive (R or RW), or other removable or fixed media drive might be provided. Storage media 514 might include, for example, a hard disk, an integrated circuit assembly, magnetic tape, cartridge, optical disk, a CD or DVD. Storage media 514 may be any other fixed or removable medium that is read by, written to or accessed by media drive 512. As these examples illustrate, the storage media 514 can include a computer usable storage medium having stored therein computer software or data.

In alternative embodiments, information storage mechanism 510 might include other similar instrumentalities for allowing computer programs or other instructions or data to be loaded into computing component 500. Such instrumentalities might include, for example, a fixed or removable storage unit 522 and an interface 520. Examples of such storage units 522 and interfaces 520 can include a program cartridge and cartridge interface, a removable memory (for example, a flash memory or other removable memory component) and memory slot. Other examples may include a PCMCIA slot and card, and other fixed or removable storage units 522 and interfaces 520 that allow software and data to be transferred from storage unit 522 to computing component 500.

Computing component 500 might also include a communications interface 524. Communications interface 524 might be used to allow software and data to be transferred between computing component 500 and external devices. Examples of communications interface 524 might include a modem or softmodem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 524 may be carried on signals, which can be electronic, electromagnetic (which includes optical) or other signals capable of being exchanged by a given communications interface 524. These signals might be provided to communications interface 524 via a channel 528. Channel 528 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 508, storage unit 520, media 514, and channel 528. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 500 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method comprising:
receiving data of a driver's face over a time interval;
for each frame of the data, determining one or more parameters associated with eye movements and characteristics of the driver;
based on the one or more parameters for each frame, featurizing the frames into one or more vectors, wherein each of the one or more vectors corresponds to a parameter of the one or more parameters;
applying a weight to each of the one or more vectors;
based on the weight of each of the one or more vectors, predicting whether the driver surpassed an intoxication threshold; and
if the driver surpassed the intoxication threshold, altering an operating characteristic of a vehicle of the driver.

2. The method of claim 1, wherein the one or more parameters comprise common characteristics, head pose, relative gaze, and patch appearance.

3. The method of claim 2, wherein the relative gaze parameter has a highest weight.

4. The method of claim 1, wherein the data comprises video data from a plurality of cameras.

5. The method of claim 1, further comprising attributing a confidence value to each of the one or more vectors and weighting the one or more vectors based on the confidence values.

6. The method of claim 5, further comprising determining an overall confidence value based on the confidence values and the weights.

7. The method of claim 1, wherein the one or more parameters evaluate how the frames change over the time interval.

8. The method of claim 1, wherein predicting whether the driver surpassed the intoxication threshold is accomplished with a temporal network.

9. A vehicle, comprising:
a sensor;
a processor; and
a memory coupled to the processor to store instructions, which when executed by the processor, cause the processor to:
receive data of a driver's face over a time interval from the sensor;
for each frame of the data, determine a relative gaze parameter;
evaluate the relative gaze parameter over the time interval to predict whether the driver surpassed an intoxication threshold; and
if the driver surpassed the intoxication threshold, alter an operating characteristic of the vehicle.

10. The vehicle of claim 9, further comprising a plurality of sensors, wherein the data comprises video data from the plurality of sensors.

11. The vehicle of claim 9, wherein the processor is further configured to attribute a confidence value to the prediction of whether the driver surpassed the intoxication threshold.

12. The vehicle of claim 9, wherein predicting whether the driver surpassed the intoxication threshold is accomplished with a temporal network.

13. The vehicle of claim 12, wherein the processor is further configured to train the temporal network based on the relative gaze parameter.

14. The vehicle of claim 9, wherein the processor is further configured to:
for each frame of the data, determine a head pose parameter, a common characteristic parameter, and a patch appearance parameter; and
evaluate the head pose parameter, the common characteristic parameter, and the patch appearance parameter over the time interval to predict whether the driver surpassed the intoxication threshold.

15. A non-transitory machine-readable medium having instructions stored therein, which when executed by a processor, cause the processor to:
receive video data of a driver's face over a time interval;
for each frame of the video data, determining one or more parameters associated with eye movements and characteristics of the driver;
based on the one or more parameters for each frame, featurize the frames into one or more vectors, wherein each of the one or more vectors corresponds to a parameter of the one or more parameters;
attribute a confidence value to each of the one or more vectors;
based on the confidence value of each of the one or more vectors, predict whether the driver surpassed an intoxication threshold; and
if the driver surpassed the intoxication threshold, alter an operating characteristic of a vehicle of the driver.

16. The non-transitory machine-readable medium of claim 15, wherein the one or more parameters comprise common characteristics, head pose, relative gaze, and patch appearance.

17. The non-transitory machine-readable medium of claim 15, wherein the processor is further configured to determine an overall confidence value based on the confidence values.

18. The non-transitory machine-readable medium of claim 15, wherein the one or more parameters evaluate how the frames change over the time interval.

19. The non-transitory machine-readable medium of claim 15, wherein predicting whether the driver surpassed the intoxication threshold is accomplished with a temporal network.

20. The non-transitory machine-readable medium of claim 19, wherein the processor is further configured to train the temporal network based on the confidence values.
